(19) United States
(12) Patent Application Publication
(10) Pub. No.: US 2025/0072707 A1
(43) Pub. Date: Mar. 6, 2025

(54) DISHWASHER DOOR-OPENING STRIKER

(71) Applicant: ILLINOIS TOOL WORKS INC., Glenview, IL (US)

(72) Inventors: Joel Charles BRAGG, Waterford, WI (US); Jeffrey John Krieger, Mukwonago, WI (US)

(73) Assignee: ILLINOIS TOOL WORKS INC., Glenview, IL (US)

(21) Appl. No.: 18/815,079

(22) Filed: Aug. 26, 2024

Related U.S. Application Data
(60) Provisional application No. 63/534,940, filed on Aug. 28, 2023.

(51) Int. Cl. A47L 15/42; A47L 15/48; E05C 17/56

(52) U.S. Cl. CPC A47L 15/4259; A47L 15/48; E05C 17/56; A47L 2501/22

(57) ABSTRACT

A latch strike mechanism for a dishwasher door to improve drying performance including a housing and a moveable striker projecting from the housing and engageable with a door latch. The moveable striker is slideably engaged with the stationary striker frame and configured to extend to maintain the dishwasher door in a partially open position following a wash cycle to allow controlled air exchange between the interior of the dishwasher and ambient conditions to improve drying performance and/or save energy.

### CROSS REFERENCE TO RELATED APPLICATION

This application claims the benefit of U.S. Provisional Application, Ser. No. 63/534,940, filed on 28 Aug. 2023. The co-pending provisional application is hereby incorporated by reference herein in its entirety and is made a part hereof, including but not limited to those portions which specifically appear hereinafter.

### BACKGROUND OF THE INVENTION

### Field of the Invention

This invention relates generally to a dishwasher latch strike, in particular a dishwasher latch strike configured to maintain a dishwasher door in an open position following a wash cycle.

Description of Prior Art

Traditional dishwasher latches include a latch and a mating striker. The latches are generally, though not always, mounted to the dishwasher door while the mating striker is mounted to the dishwasher tub. Such latches may include an over-center spring and cam mechanism or similar configuration to pull the door tight with the tub against a gasket to prevent water leakage during the wash cycle thereby maintaining a watertight seal. In most dishwashers, the striker is a simple and fixed/nonmoving mechanical piece that is snapped into features provided by the tub or attached to the tub with mounting screws. The door latch also generally includes an electrical switch to indicate when the door is open (and/or closed).

Most dishwasher cycles run entirely with the dishwasher door in the closed position. The dish drying function is generally provided by vent and heating mechanisms. The vent mechanism provides openings in the enclosure that promotes air flow. The heating mechanism promotes drying but consumes energy inefficiently. It is also known that after the wash cycle is complete, opening the dishwasher door increases airflow to improve drying performance. Today, a small number of specialty dishwashers open the door to improve drying performance.

In North America, one such dishwasher uses a thermal actuator and lever mechanism to provide force and travel to push the door open. In Europe, another such dishwasher uses a large AC synchronous motor and gearbox actuator to do this. In both examples when the door is pushed open, the door latch cam is moved to the open position, just as if a user had physically pulled the door open. Since the door and latch are now decoupled, expensive and complex features are added to the hinges and door counterbalance springs to prevent the door from falling to the horizontal/fully open position.

One additional method includes a complicated motor, switch, sensor, and telescopic striker mechanism. Instead of having a handle on the door for a user to pull, the user knocks twice on the dishwasher panel. A sensor on the control board detects the knocking sound, and a motor extends the length of the telescopic striker, allowing the user to decouple the latch from the strike and fully open the door. The same motor and telescopic striker mechanism partially opens the door at the appropriate time during the cycle to dry the dishes. Since the striker is telescopic, the latch and striker remain coupled together when it is partially open. Although additional features do not need to be added to the dishwasher hinge or counterbalance springs, this design is quite complicated and expensive, with limit switches to indicate the position status, and a clutch to prevent finger pinching injuries.

A need therefore exists for a lower cost and complexity solution to promote efficient drying cycles and reduced energy consumption.

### SUMMARY OF THE INVENTION

The invention generally relates to a system, method and apparatus for releasing and propping a dishwasher door open during the drying cycle to improve drying performance.

A preferred embodiment utilizes a cost-effective latch mechanism that can be generally applied to less expensive/high-volume dishwashers. It improves dishwasher drying performance, but without the cost of features added to the dishwasher hinges and door springs, or expensive motorized gearboxes, limit switches, clutches, or sensors. The new solution is a 1-way mechanism. At the appropriate time after the wash cycle, the dishwasher control sends a signal to an actuator within the strike assembly to release a strike, which allows gasket pressure and the door bias spring to push the dishwasher door open by a specific amount. The amount of travel is selected to optimize drying of the dishes and is controlled by the dimensions and a catch feature on the movable striker; it stops on the base housing. The striker preferably includes a movable component, the “moveable striker,” and a stationary component, the “stationary striker frame,” which permit this device to be added to the dishwasher without an additional door switch and harness connection. The movable striker extends to provide the opening in the dishwasher enclosure to promote airflow, while the latch and striker remain coupled. The stationary striker frame closes the latch door switch only when the striker mechanism is retracted.

This arrangement, without the expense of an extra switch, prevents the appliance from running when the door is open, which could cause water damage to a consumer's home. After the door opens and the dishes dry, the cycle is complete. The consumer tugs the door open to remove the clean dishes, and then closes the door. The natural act of closing the door resets the device back to the home or retracted position, so the appliance is ready to be used again.

Other objects and advantages will be apparent to those skilled in the art from the following detailed description taken in conjunction with the appended claims and drawings.

### BRIEF DESCRIPTION OF THE DRAWINGS

FIG. 1 shows a top perspective view of a latch strike mechanism according to one embodiment;

FIG. 2 shows a top perspective view of a latch strike mechanism according to one embodiment;

FIG. 3 shows an exploded perspective view of the latch strike mechanism shown in FIG. 1;

FIG. 4 shows an exploded perspective view of the latch strike mechanism shown in FIG. 1 from the opposite side of FIG. 3.

FIG. 5 shows a top perspective view of the latch strike mechanism shown in FIG. 1, without a top portion of the housing;

FIG. 6 shows a top view of the latch strike mechanism shown in FIG. 5;

FIG. 7 shows a rear cross-sectional view of the latch strike mechanism shown in FIG. 1 taken along section 7-7 from FIG. 6;

FIG. 8 shows a side cross-sectional view of the latch strike mechanism shown in FIG. 1 taken along section 8-8 from FIG. 6;

FIG. 9 shows a top perspective view of the latch strike mechanism shown in FIG. 2, without a top portion of the housing;

FIG. 10 shows a side cross-sectional view of the latch strike mechanism shown in FIG. 2 taken along section 10-10 from FIG. 9;

FIG. 11 shows a perspective view of the latch strike mechanism shown in FIG. 2, without a top portion of the housing;

FIG. 12 shows a top view of the latch strike mechanism shown in FIG. 2, without a top portion of the housing;

FIG. 13 shows a rear cross-sectional view of the latch strike mechanism shown in FIG. 2 taken along section 13-13 from FIG. 12;

FIG. 14 shows a side cross-sectional view of the latch strike mechanism shown in FIG. 2 taken along section 14-14 from FIG. 12;

FIG. 15 shows a top view of a latch strike mechanism according to one embodiment;

FIG. 16 shows a top view of a latch strike mechanism according to one embodiment; and

FIG. 17 shows a schematic of a dishwasher using the subject latch strike mechanism.

### DETAILED DESCRIPTION OF THE INVENTION

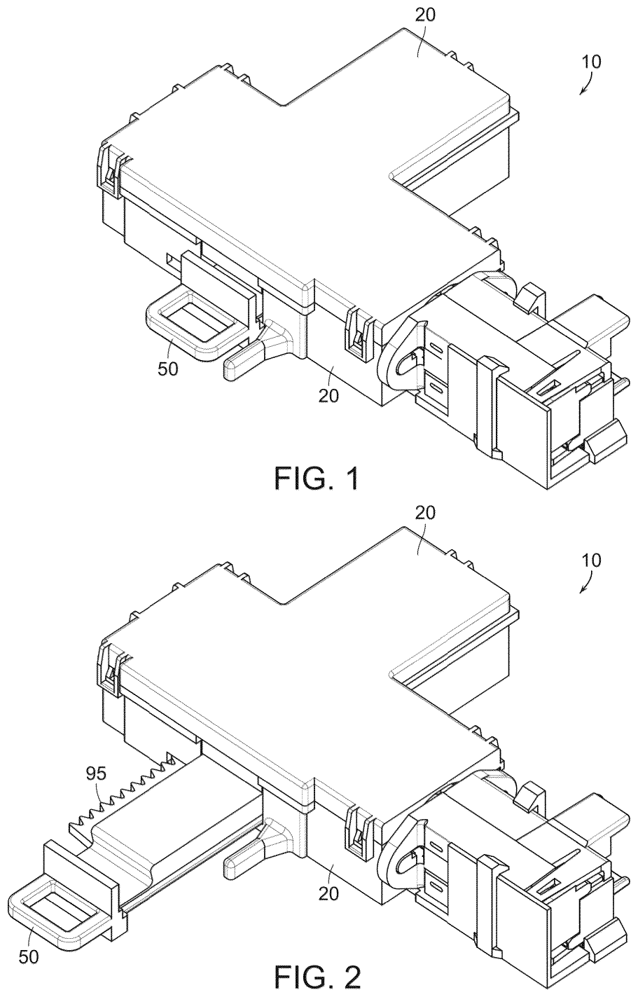

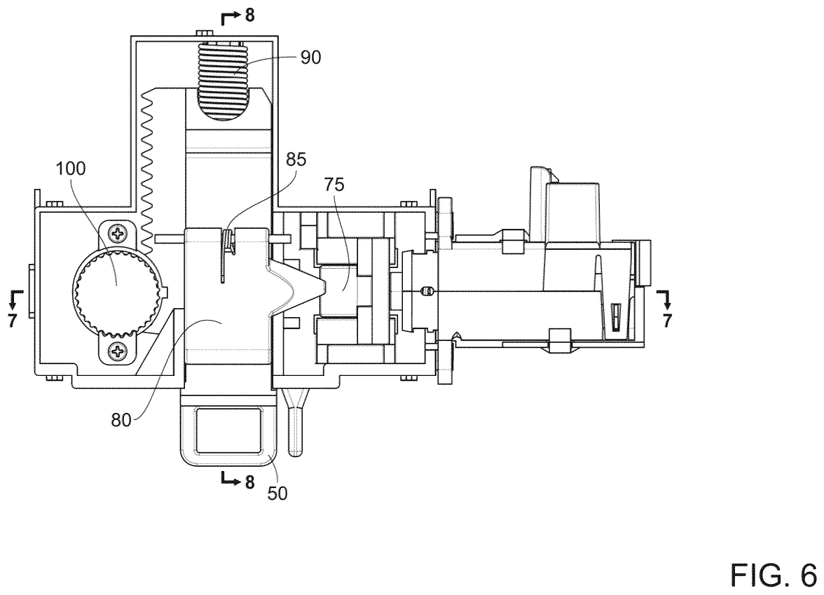

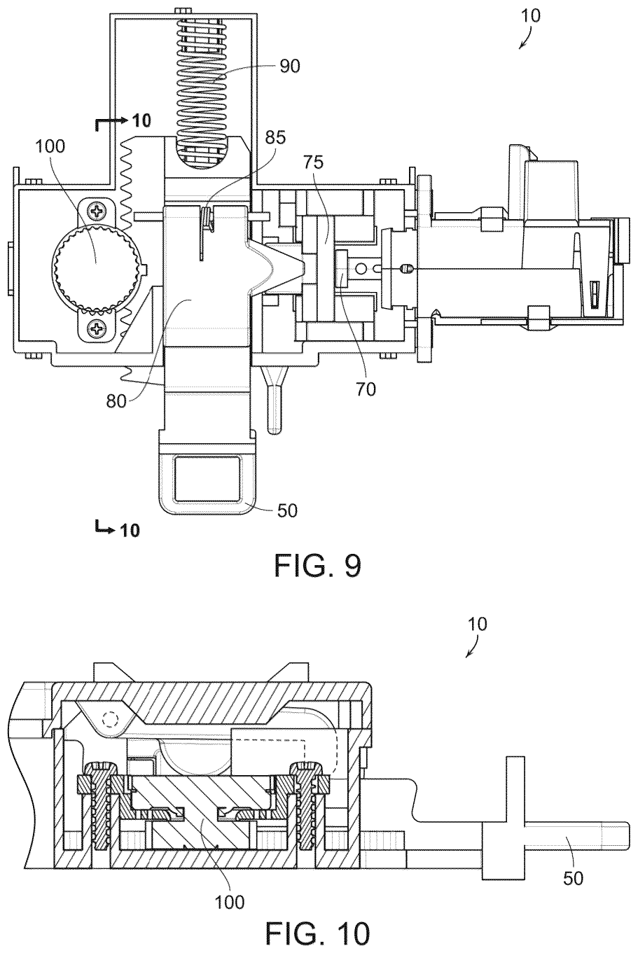

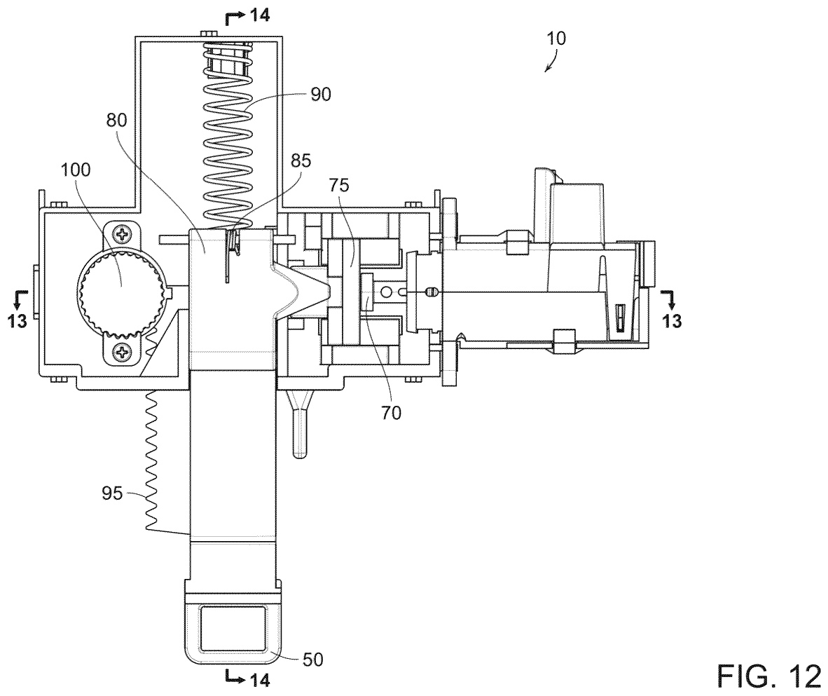

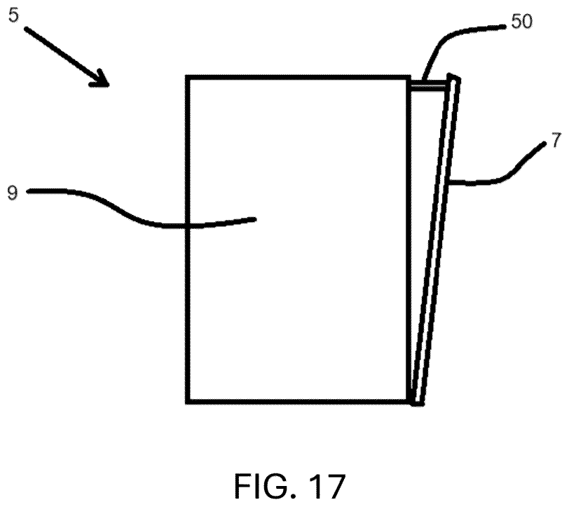

FIGS. 1-16 show various embodiments and positions of a latch strike mechanism 10 for a dishwasher 5. As described, the subject latch strike mechanism 10 is configured to improve drying performance by maintaining a dishwasher door 7 in a slightly open position following a drying cycle. FIG. 17 shows a schematic of a dishwasher 5 with a dishwasher door 7 propped open by the subject latch strike mechanism 10.

The latch strike mechanism 10 preferably includes a housing 20 for accommodating the various internal components and for mounting to one of a dishwasher tub 9 or a dishwasher door 7. In a preferred embodiment the latch strike mechanism 10 is mounted to the dishwasher tub 9 although it is contemplated that the assembly may be reversed for integration with the dishwasher door 7. FIGS. 1, 5, and 6 best show the latch strike mechanism 10 in a closed, retracted position and FIGS. 2, 9, and 11 best show the latch strike mechanism 10 in a fully open, extended position, as described in more detail herein.

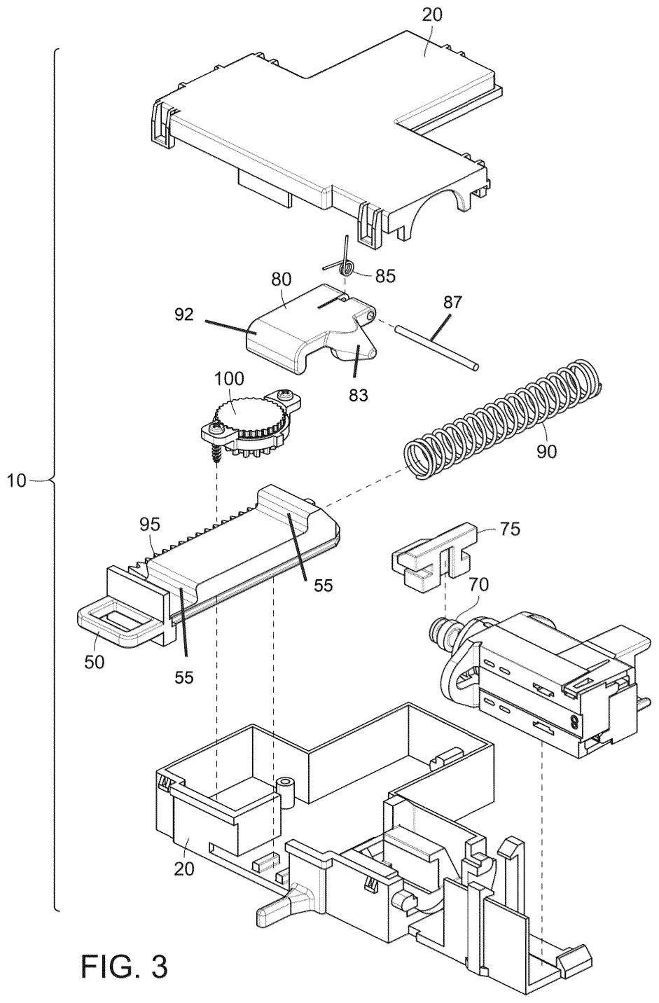

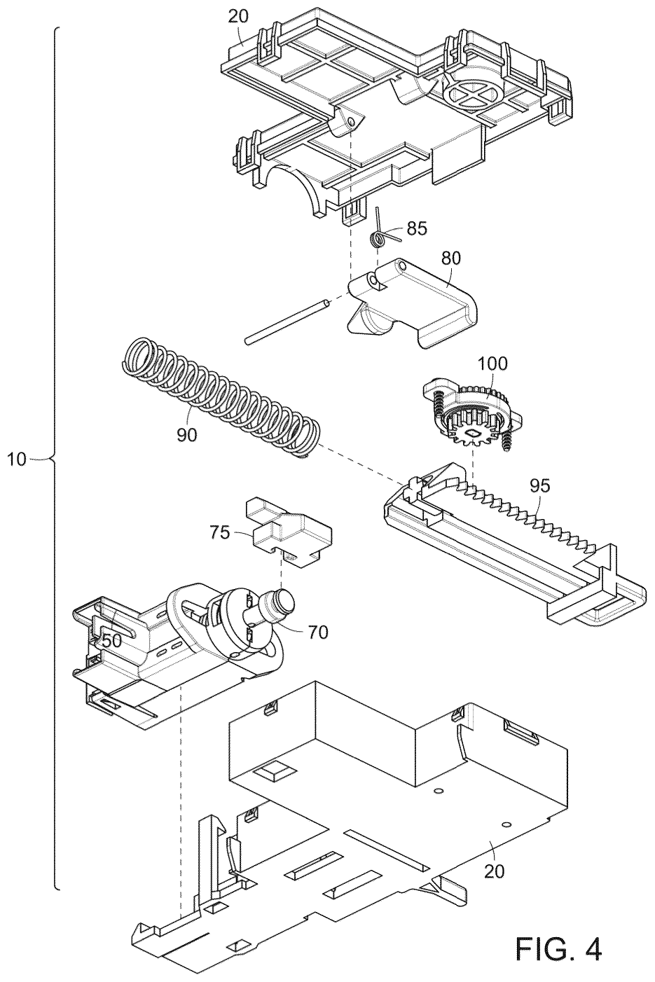

FIGS. 3 and 4 show exploded views of the latch mechanism 10 according to one embodiment. A moveable striker 50 is preferably projectable from the housing 20 and is engageable with a door latch in the dishwasher door 7. The moveable striker 50 is preferably configured to slide relative to the housing 20 and more specifically may be slideably engaged with or within the housing 20, such as along a track 95. The track 95 may be engageable with a damper gear 100 between a retracted and extended position.

The moveable striker 50 is configured to extend relative to the dishwasher door 7, preferably in engagement with the door latch and/or another portion of the dishwasher door 7 to thereby maintain the dishwasher door 7 in a partially open position, as shown schematically in FIG. 17. A partially open position of the dishwasher door is defined as a position between fully closed and sealed relative to the dishwasher tub and fully open and thereby perpendicular to an open face of the dishwasher tub. By maintaining the dishwasher door 7 in a partially open position, the dishwasher tub 9 is vented to ambient conditions and thereby may effect a more complete drying of the dishes within the dishwasher either during the drying cycle or immediately after the drying cycle.

As such, the moveable striker 50 is preferably used and configured to partially open the dishwasher door 7 while remaining latched and maintain the dishwasher door 7 in the partially open position.

In one embodiment of the latch strike mechanism 10, the moveable striker 50 is configured to extend when a wash cycle of the dishwasher is complete. In an alternative embodiment, the moveable striker 50 is configured to extend when the drying cycle is started. In yet another embodiment, the moveable striker 50 is configured to extend when the drying cycle is completed.

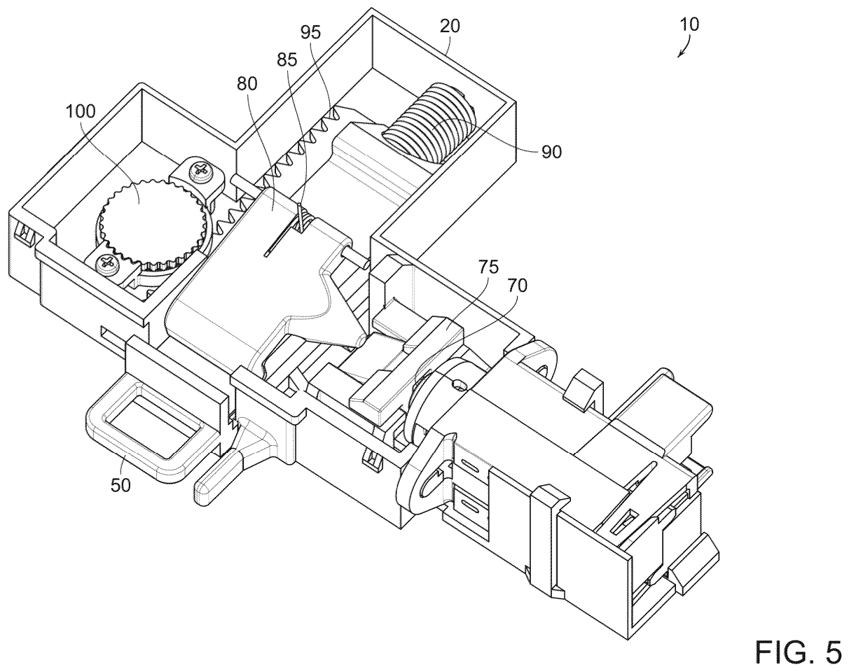

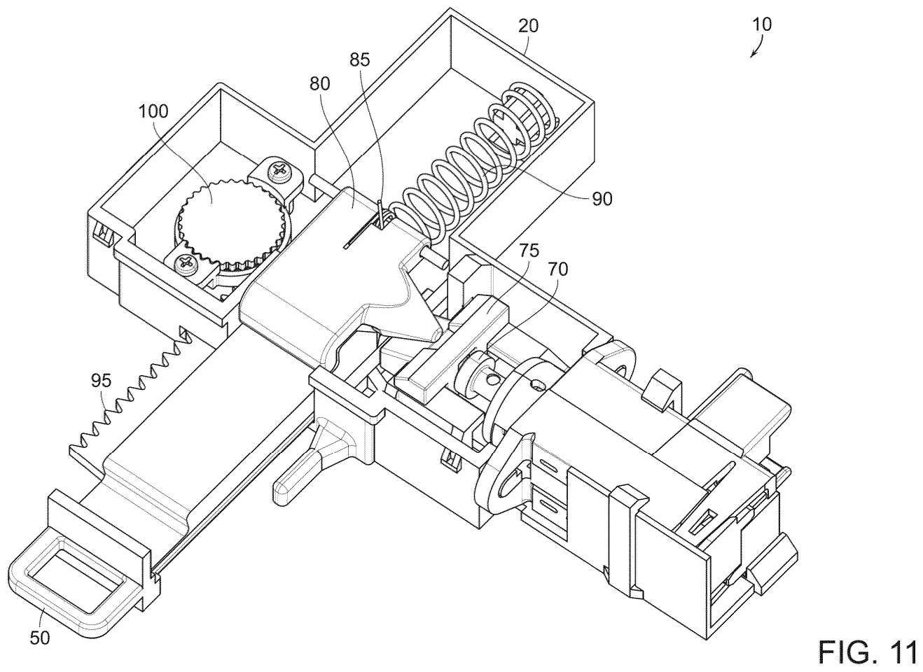

As best shown between FIGS. 5 and 11, the moveable striker 50 may be connected with respect to a spring 90 within the housing 20 and is slideable within the housing 20 and spring-biased relative to the housing 20.

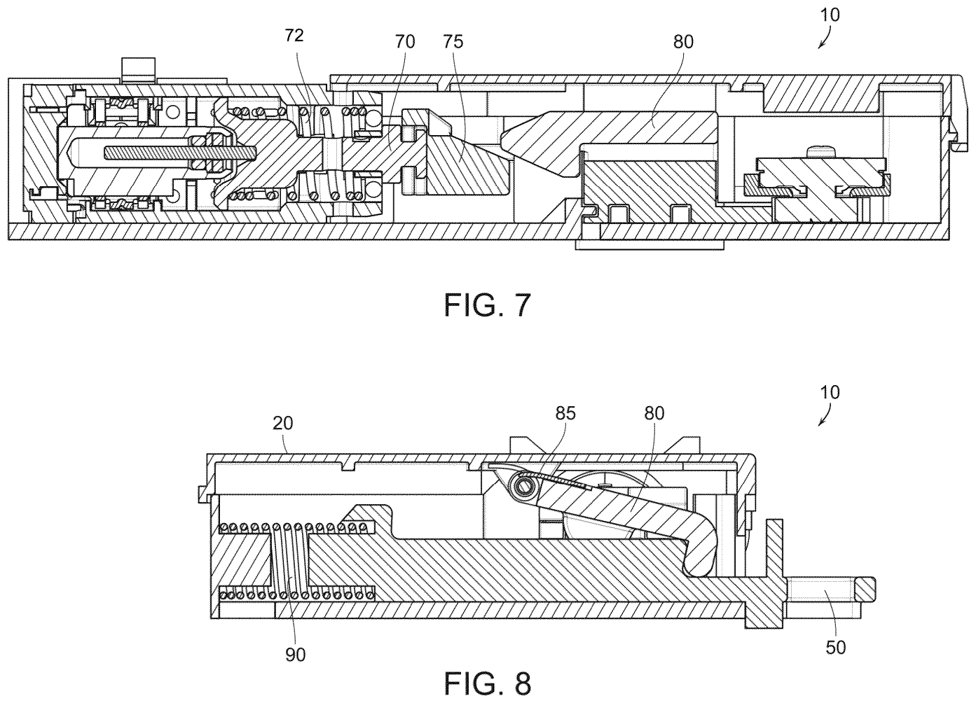

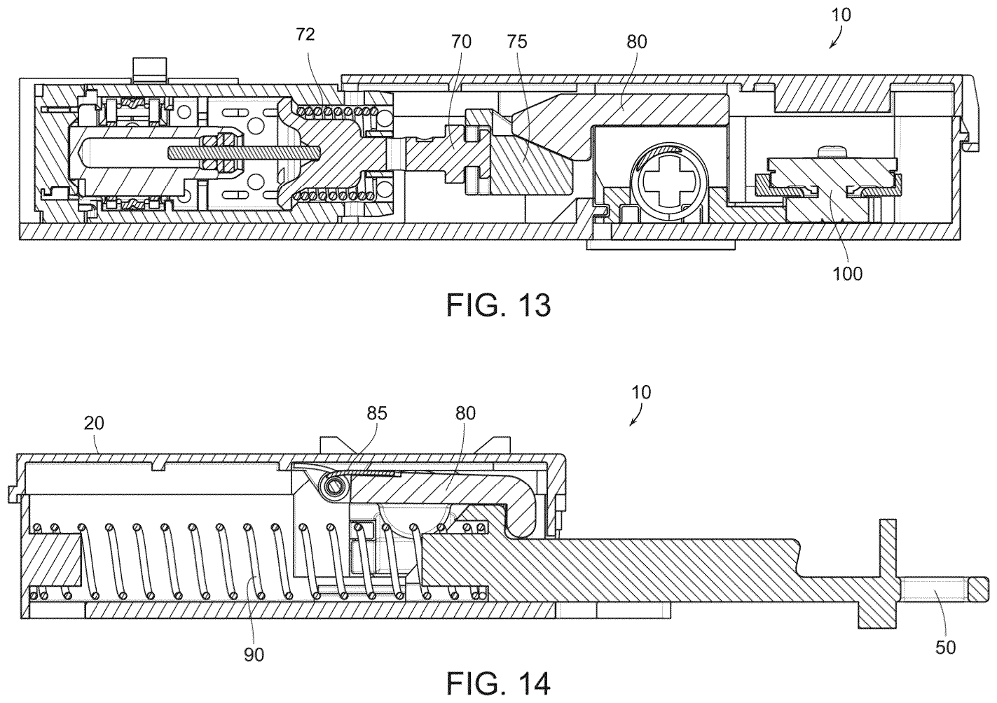

As shown in FIGS. 3 and 4, the latch strike mechanism 10 may further include an actuator 70 positioned within the housing 20 and engageable with a release plate 80. The actuator 70 may include an actuator spring 72 as shown in cross-section in FIGS. 7 and 13. In addition, the actuator 70 include a wedge 75 that engages with the release plate 80 to effect a desired rotation or pivot action. In one embodiment, the wedge 75 is engageable with a conical element 83 on the release plate 80 to provide the desired pivoting action of the release plate 80 relative to the moveable striker 50.

The release plate 80 is positioned within the housing 20 between the actuator 70 and the moveable striker 50. The release plate 80 may include a conical element 83 for engagement with the wedge 75 of the actuator 70. Additionally, the release plate 80 may include an axle 87 about which to pivot, as best shown in FIGS. 3 and 4. FIG. 8 shows the engagement between the release plate 80 and the moveable striker 50 in a closed, retracted position while FIG. 14 shows this engagement in the open, extended position. The actuator 70 may be configured to actuate upon completion of the wash cycle, beginning of the drying cycle, or ending of the drying cycle. As shown in the figures, the actuator 70 may be positioned to extend and retract perpendicularly with respect to a direction of travel of the moveable striker 50.

The actuator 70 preferably prevents rotation of the release plate 80 in a retracted position, such as shown in FIG. 8, and permits rotation of the release plate 80 in an extended position, as shown in FIG. 14. Following engagement by the actuator 70 with the release plate 80, the rotation of the release plate 80 relative to a plane of movement of the moveable striker 50 preferably releases the spring 90 to extend the moveable striker 50. This action is best shown from FIG. 8 to FIG. 14. In this way, the release plate 80 is pivotable between the retracted position and the extended position. Alternatively, or in addition, the release plate 80 may be slideable between the retracted position and the extended position. As shown in FIGS. 8 and 11, a release plate spring 85 is preferably positioned between the housing 20 and the release plate 80 to bias the release plate 80 toward the retracted position.

As shown in FIGS. 3 and 4 and FIGS. 8 and 14, the release plate 80 may include a leading edge 92 that engages with one of at least two curbs or detents 55 positioned along a length of the moveable striker 50. The at least two detents 55 are preferably located in a fully retracted, closed position of the latch mechanism 10 and a fully extended, open position of the latch mechanism 10.

According to preferred embodiments of the invention, the actuator 70 may comprise a wax motor thermal actuator, solenoid, a motor, and/or a shape memory alloy. The actuator 70 may be thermally actuated by a temperature, such as a desired or set temperature within a drying cycle.

According to one preferred embodiment of this invention, shown in FIGS. 1-14, a damper gear 100 may be positioned relative to the moveable striker 50, specifically along the track 95 formed in or with respect to the moveable striker 50. The damper gear 100 is preferably configured to slow the extension of the moveable striker 50 along the track 95 relative to the bias force of the spring 90. In this way, the dishwasher door 7 may slowly, gradually, and in a measured manner open relative to the dishwasher tub as the moveable striker 50 slides to the extended, open position.

In one embodiment, an additional door position switch (not shown) may be configured to activate a tub light within the dishwasher tub or provide the dishwasher control with an additional level of safety.

According to a preferred embodiment, the latch strike mechanism 10 as described herein is configured to be reset when the dishwasher door is closed by a user. Specifically, the moveable striker 50 is configured slide to the retracted position thereby resetting latch mechanism 10 and/or the actuator 70 by the act of closing the dishwasher door.

A corresponding method for operating the latch strike mechanism 10 for a dishwasher door includes providing the moveable striker 50 projecting from the housing 20 and engageable with the door latch. A subsequent sliding of the moveable striker 50 relative to the housing 20 preferably extends against at least a portion of the dishwasher door to maintain the dishwasher door in a partially open position.

The subject method and sliding of the moveable striker 50 may be activated by an actuator upon completion of a wash cycle and/or beginning and/or ending of the drying cycle whereby the release plate 80 pivots with following contact from the actuator 70 to the extended position from the retracted position. The release plate 80 may pivot to release the spring 90 upon rotation of the release plate 80 and thereby extend the moveable striker 50 relative to the housing 20.

In one embodiment of the subject invention, the spring 90 providing bias relative to the dishwasher door may be omitted due to the dishwasher gasket force and door counterbalance springs that are often present in conventional dishwashers.

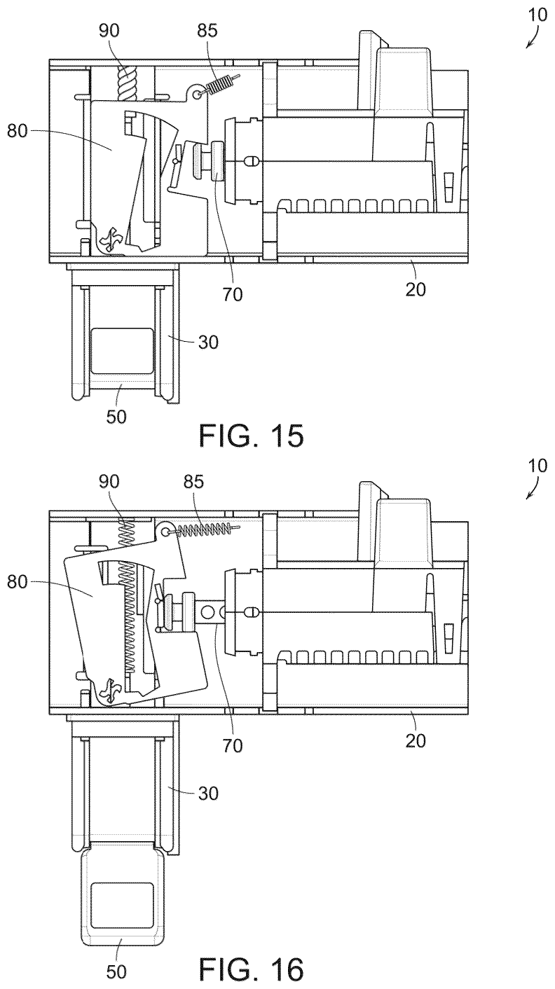

FIGS. 15 and 16 show one alternative embodiment of the strike latch mechanism wherein a stationary striker frame 30 preferably projects from the housing 20 and is engageable with a door latch in the door. A moveable striker 50 is preferably configured to slide relative to the stationary striker frame 30 and more specifically may be slideably engaged with or within the stationary striker frame 30. The moveable striker 50 is configured to extend relative to the dishwasher door, preferably in engagement with the door latch and/or another portion of the dishwasher door to thereby maintain the dishwasher door in a partially open position. A partially open position of the dishwasher door is defined as a position between fully closed and sealed relative to the dishwasher tub and fully open and thereby perpendicular to an open face of the dishwasher tub. By maintaining the dishwasher door in a partially open position, the dishwasher tub is vented to ambient conditions and thereby may effect a more complete drying of the dishes within the dishwasher either during the drying cycle or immediately after the drying cycle.

As such, the moveable striker 50 is preferably used and configured to partially open the dishwasher door while remaining latched and maintain the dishwasher door in the partially open position. The stationary striker frame is preferably used and configured to trigger an indicator switch of the latch.

As best shown between FIGS. 15 and 16, in this embodiment, the moveable striker 50 may be connected with respect to a spring 90 within the housing 20 and is slideable within the stationary striker frame 30 and spring-biased relative to the housing 20.

The actuator 70 in this embodiment preferably prevents rotation of the release plate 80 in a retracted position, such as shown in FIG. 15, and permits rotation of the release plate 80 in an extended position, as shown in FIG. 16. Unlike the rotation shown in FIGS. 1-14, the release plate 80 in this embodiment rotates in a plane of movement of the moveable striker 50. Following engagement by the actuator 70 with the release plate 80, the rotation of the release plate 80 preferably releases the spring 90 to extend the moveable striker 50 relative to the stationary striker frame 30. This action is best shown from FIG. 15 to FIG. 16. In this way, the release plate 80 is pivotable between the retracted position and the extended position. Alternatively, or in addition, the release plate 80 may be slideable between the retracted position and the extended position. As shown in FIGS. 15 and 16, in this embodiment, a release plate spring 85 is preferably positioned between the housing 20 and the release plate 80 to bias the release plate 80 toward the retracted position.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A latch strike mechanism for a dishwasher door to improve drying performance, the latch mechanism comprising:
a housing;
a moveable striker slideably engaged with the housing, the moveable striker configured to extend to maintain the dishwasher door in a partially open position.

2. The latch strike mechanism of claim 1 wherein the moveable striker is configured to extend when a wash cycle of the dishwasher is complete.

3. The latch strike mechanism of claim 1 wherein the moveable striker is slideable within the housing along a track and spring biased relative to the housing.

4. The latch strike mechanism of claim 1 wherein the housing further comprises an actuator engageable with a release plate upon completion of a wash cycle.

5. The latch strike mechanism of claim 4 wherein the actuator prevents movement of the release plate in a retracted position and permits movement of the release plate in an extended position.

6. The latch strike mechanism of claim 5 wherein the movement of the release plate releases a spring to extend the moveable striker relative to the stationary striker frame.

7. The latch strike mechanism of claim 4 wherein the release plate is at least one of pivotable and slideable between a retracted position and an extended position.

8. The latch strike mechanism of claim 4 wherein the actuator is thermally actuated by a temperature of a drying cycle.

9. The latch strike mechanism of claim 4 wherein the actuator comprises one of a wax motor thermal actuator, solenoid, motor, and shape memory alloy.

10. The latch strike mechanism of claim 1 further comprising a damper gear positioned relative to a track of the moveable striker and configured to slow the extension of the moveable striker relative to the housing.

11. The latch strike mechanism of claim 1 further comprising an additional door position switch configured to activate a tub light or maintain product safety.

12. The latch strike mechanism of claim 1 wherein the actuator is positioned to extend and retract perpendicularly with respect to a travel of the moveable striker.

13. A method for operating a latch strike mechanism for a dishwasher door to improve drying performance, method comprising:
providing a housing with a moveable striker engageable with a door latch;
sliding the moveable striker relative to the housing to extend the dishwasher door to maintain the dishwasher door in a partially open position, the moveable striker slideable between two detents.

14. The method of claim 13 further comprising:
activating an actuator upon completion of a wash cycle; and
moving a release plate with the actuator to an extended position, allowing translation of the moveable striker.

15. The method of claim 14 further comprising:
moving the release plate upon activation of the actuator to the extended position from a retracted position, allowing translation of the moveable striker between the two detents.

16. The method of claim 15 further comprising:
releasing a spring upon rotation of the release plate; and
extending the moveable striker relative to the stationary striker frame.

17. The method of claim 15 further comprising:
pivoting the release plate upon activation of the actuator to the extended position from a retracted position.

18. The method of claim 15 further comprising:
sliding the release plate upon activation of the actuator to the extended position from a retracted position.

19. The method of claim 13 further comprising:
resetting the latch mechanism by manually closing the door.

20. A latch strike mechanism for a dishwasher door to improve drying performance, the latch mechanism comprising:
a housing;
a stationary striker frame projecting from the housing and engageable with a door latch;
a moveable striker slideably engaged with the stationary striker frame, the moveable striker configured to extend to maintain the dishwasher door in a partially open position.
